(19) United States
(12) Patent Application Publication
(10) Pub. No.: US 2011/0053509 A1
(43) Pub. Date: Mar. 3, 2011

(54) Modular Dual Radio Headset

(75) Inventor: Soohyun Ham, San Francisco, CA (US)

(73) Assignee: PLANTRONICS, INC., Santa Cruz, CA (US)

(21) Appl. No.: 12/553,268

(22) Filed: Sep. 3, 2009

(51) Int. Cl. H04B 7/00

(52) U.S. Cl. 455/41.3

(57) ABSTRACT

Methods and apparatuses for modular dual radio headsets are disclosed. In one example, a headset system includes a secondary radio module and a headset module. The secondary radio module may be removably coupled to the headset module.

### BACKGROUND OF THE INVENTION

Consumers typically have more than one electronic device that provides for the use of a headset to enhance the user experience. For example, the user may have one or more telecommunications devices with which the user operates wireless headsets for hands-free communication. The user may utilize wireless headsets in a variety of locations, including at the office, at home, or while mobile such as while traveling in a vehicle. The user may also have one or more multimedia devices or portable computing devices that provides for the use of a headset to listen to audio output such as music. As the variety of devices and usage scenarios for wireless headsets increase, there is a need for increased operational flexibility.

As a result, improved methods and apparatuses for headsets and headset operation are needed.

### BRIEF DESCRIPTION OF THE DRAWINGS

The present invention will be readily understood by the following detailed description in conjunction with the accompanying drawings, wherein like reference numerals designate like structural elements.

FIG. 1A illustrates a modular headset system including a headset module and a secondary radio module removably coupled together.

FIG. 1B illustrates a modular headset system including a headset module and a secondary radio module in an uncoupled state.

FIGS. 2A and 2B illustrate a perspective view and side view, respectively, of the headset module shown in FIGS. 1A and 1B.

FIG. 3 illustrates a simplified block diagram of a headset module in one example.

FIG. 4 illustrates a simplified block diagram of a secondary radio module in one example.

FIG. 5 illustrates a simplified block diagram of a secondary radio module in a further example.

FIG. 6 illustrates a block diagram of a modular headset system in one example.

FIG. 7 is a flow diagram illustrating a process for operating a modular headset system in one example.

FIG. 8 illustrates recharging of a secondary radio module in a headset base in one example.

FIGS. 9-11 illustrate usage scenarios for a modular headset system.

### DESCRIPTION OF SPECIFIC EMBODIMENTS

Methods and apparatuses for modular headsets are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

This invention relates to modular dual radio headsets. In the prior art, headset users may utilize multiple wireless headsets. For example, in one usage scenario, a user has a Bluetooth enabled mobile phone which is used in and outside of the office. The user has a Bluetooth headset paired with the Bluetooth mobile phone. In addition to a mobile phone, the user also has a landline telephone and may have a PC with telecommunications software such as a VoIP application (also referred to as a softphone application). In a typical case, the user may have a Digital Enhanced Cordless Telecommunications (DECT) radio headset for use with the landline telephone and/or PC. With this DECT headset, the user may make or receive calls using the landline telephone or PC and conduct the call with the DECT headset.

However, if a call comes into the user's mobile phone, the DECT radio headset cannot be used to answer the mobile phone call. In the case of heavy phone users whose calls can come from multiple devices, and where the user prefers or requires hands-free use, the user must keep two separate headsets within reach and switch there between to manage their calls in order to be productive. Many users find that keeping track of and using two different headsets is cumbersome.

The inventor has recognized that with increased use of wireless headsets, there is a need for headsets capable of operating with devices using different wireless communication protocols. The inventor has also recognized that the headset form factor should provide the user with the convenience and flexibility of operating and transporting the headset in a variety of locations and environments.

In one example, a headset system includes a first radio module and a headset module. The first radio module includes a first radio transceiver and a first connection interface. The headset module includes a second radio transceiver, a processor, a speaker, a microphone, a battery, a user interface, and a second connection interface adapted to removably couple to the first connection interface. The headset module is adapted to utilize either the first radio transceiver or the second radio transceiver when coupled to the first radio module.

In one example, a headset system includes a secondary radio module and a headset module. The secondary radio module includes a first radio, a first battery, a first user interface, and a first connection interface. The headset module includes a second radio, a processor, a speaker, a microphone, a second battery, and a second user interface. The headset module further includes a second connection interface adapted to removably couple to the first connection interface, and a memory storing a dual radio application configured to receive a call over the first radio or the second radio upon detection of a coupled secondary radio module.

In one example, a headset system includes a DECT module and a Bluetooth headset module. The DECT module includes a DECT radio and a first connection interface. The Bluetooth headset module includes a Bluetooth radio transceiver, a processor, a speaker, a microphone, a battery, and a user interface. The Bluetooth headset module further includes a second connection interface adapted to removably couple to the first connection interface and a memory storing a dual radio application configured to operate the headset system in a dual radio mode upon detection of a coupled DECT module.

In one example, a computer readable medium stores instructions that when executed by a computer cause the computer to perform a method for operating a modular headset. The method includes detecting coupling or decoupling of a secondary radio module to a headset, and responsive to detecting coupling of the secondary radio module, switching from a single radio mode to a dual radio mode. The method further includes receiving an incoming call on either a first radio or a second radio while in a dual radio mode, and receiving a user interface action at the headset to connect the incoming call.

In one example, a modular dual radio headset is a wireless communication/multimedia headset which is configured to be used as either a Bluetooth headset with other Bluetooth devices such as mobile phones and computers, or a DECT headset with a DECT radio base. The modular dual radio headset includes a Bluetooth headset module and DECT radio module. The Bluetooth headset module functions as a stand alone Bluetooth headset which can be used with a Bluetooth mobile phone and other Bluetooth enabled devices. The Bluetooth headset module contains a speaker, microphone, Bluetooth radio/antenna, battery, printed circuit board assembly (PCBA), and charging elements. The DECT radio module contains a separate DECT radio/antenna, battery, PCBA and charging elements.

In one usage scenario, the user can couple and decouple the Bluetooth headset module to the DECT radio module. The DECT radio module is paired to a landline phone and/or a PC running a VOIP application. In this manner, the modular dual radio headset advantageously allows the user to answer landline, VOIP and mobile phone calls with a single headset. By using a DECT link, the user need not compromise the call quality of the landline phone. However, while roaming outside the DECT wireless range, the user can still make/answer calls on a mobile phone with the same headset.

These methods and apparatuses provide users with a highly flexible hands-free experience in Unified Communications systems, whether a user is in the office, at home, on campus, or mobile. The modular solution advantageously allows a smaller form factor of the headset when used as a standalone Bluetooth headset, whereby the user can decouple the DECT radio module and therefore need not unnecessarily carry the DECT radio module when outside of DECT wireless range.

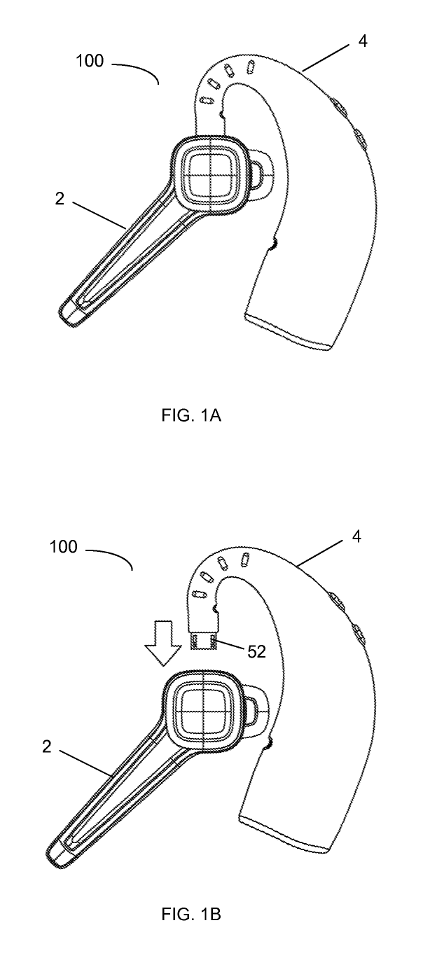

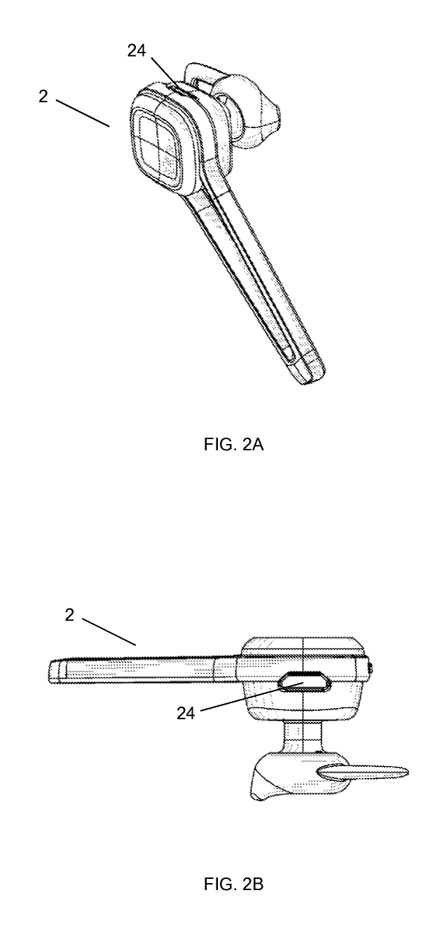

Referring now to FIG. 1A, a modular headset system 100 includes a headset module 2 and a secondary radio module 4 removably coupled together. In the example shown in FIG. 1A, headset module 2 utilizes an earbud form factor and the secondary radio module 4 utilizes an over the ear or an ear loop form factor. In further examples, other form factors may be utilized. FIG. 1B shows the modular headset system 100 whereby the headset module 2 and secondary radio module 4 are in a de-coupled state. As shown in FIG. 1B, secondary radio module 4 includes a headset module interface 52 for coupling and decoupling to the headset module 2. In one example, headset module interface 52 is a mini-USB connector component which mates with a corresponding connector component at headset module 2. In further examples, headset module interface 52 may be any interface capable of signal transfer. For example, micro-USB connectors may be used or other types of plug and receptacle connectors.

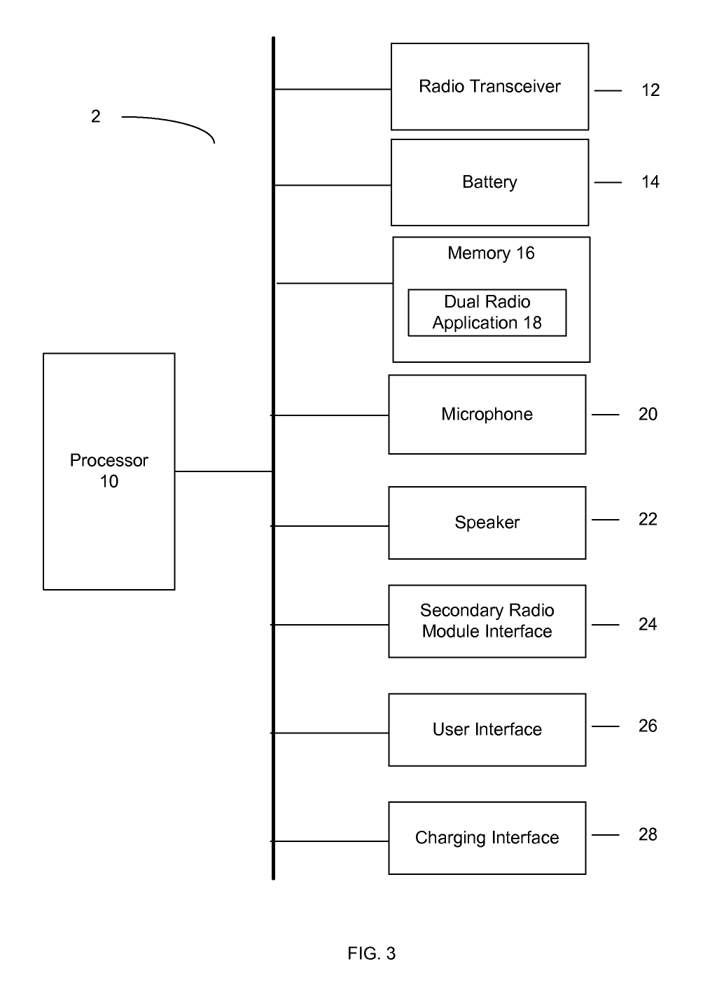

FIGS. 2A and 2B illustrate a perspective view and side view, respectively, of the headset module 2 shown in FIGS. 1A and 1B. As shown in FIGS. 2A and 2B, headset module 2 includes a secondary radio module interface 24 for coupling and decoupling with headset module interface 52 of the secondary radio module 4.

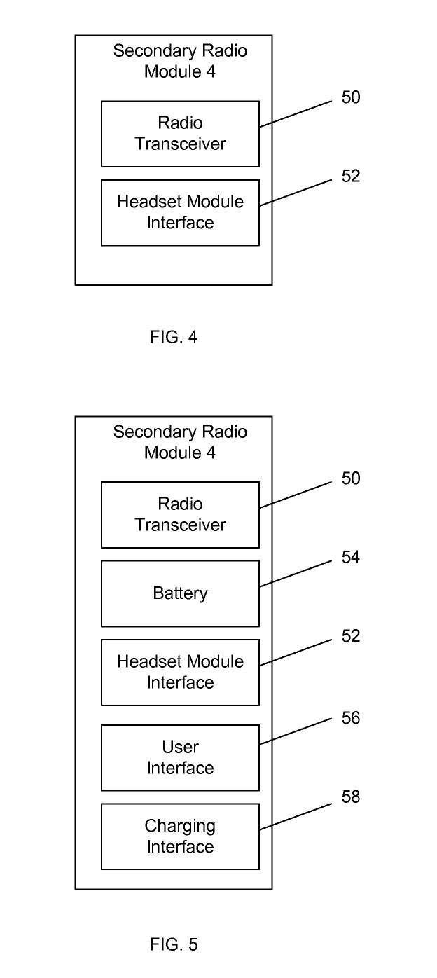

FIG. 3 shows a simplified block diagram of the headset module 2 shown in FIGS. 1A and 1B capable of operating in a single radio mode or a dual radio mode dependent on whether the secondary radio module 4 is connected. Headset module 2 includes a processor 10 operably coupled to a radio transceiver 12 (the term “radio transceiver” is also referred to herein simply as a “radio”), battery 14, memory 16, microphone 20, speaker 22, secondary radio module interface 24, user interface 26, and charging interface 28. In one example, secondary radio module interface 24 and charging interface 28 may be integrated into a single interface. For example, a mini-USB connector may serve as both a secondary radio module interface and a charging interface. Secondary radio module interface 24 is utilized to removably couple headset module 2 to headset module interface 52 on secondary radio module 4.

In one example, memory 16 stores a dual radio application 18 which when executed by processor 10 operates the modular dual radio headset in a dual radio mode upon detection of a coupled secondary radio module 4. For example, the dual radio application 18 is configured to allow the user to conduct a call, receive a call or make a call at modular headset system 100 over either the radio transceiver 12 or a transceiver at the secondary radio module 4.

Radio transceiver 12 provides for communications with a wireless local area network (LAN) radio transceiver. The radio transceiver 12 may communicate using any of various protocols known in the art for wireless connectivity. For example, radio transceiver 12 may communicate using Bluetooth, DECT, wireless fidelity (WiFi), or ultra wideband (UWB) radio for access to a device or network.

Processor 10 allows for processing data, in particular managing data between secondary radio module interface 24, dual radio application 18, memory 16, microphone 20, and speaker 22. In one example, dual radio application 18 determines the connection state of secondary radio module 4 to secondary radio module interface 24. Although shown as a separate application, dual radio application 18 may be integrated with the general operational firmware of headset module 2.

In one example, processor 10 is a high performance, highly integrated, and highly flexible system-on-chip (SOC). Processor 10 may include a variety of processors (e.g., digital signal processors), with conventional CPUs being applicable.

Memory 16 may include a variety of memories, and in one example includes SDRAM, ROM, flash memory, or a combination thereof. Memory 16 may further include separate memory structures or a single integrated memory structure. In one example, memory 16 may be used to store passwords, network and telecommunications programs, and/or an operating system (OS).

User interface 26 allows for manual communication between the headset user and the headset, and in one example includes an audio and/or visual interface such that a prompt may be provided to the user's ear and/or an LED may be lit. User interface 26 may include buttons, switches, or touch sensors to receive call initiate, call answer, power on/off, menu navigation, or multimedia output control user input actions and user preferences.

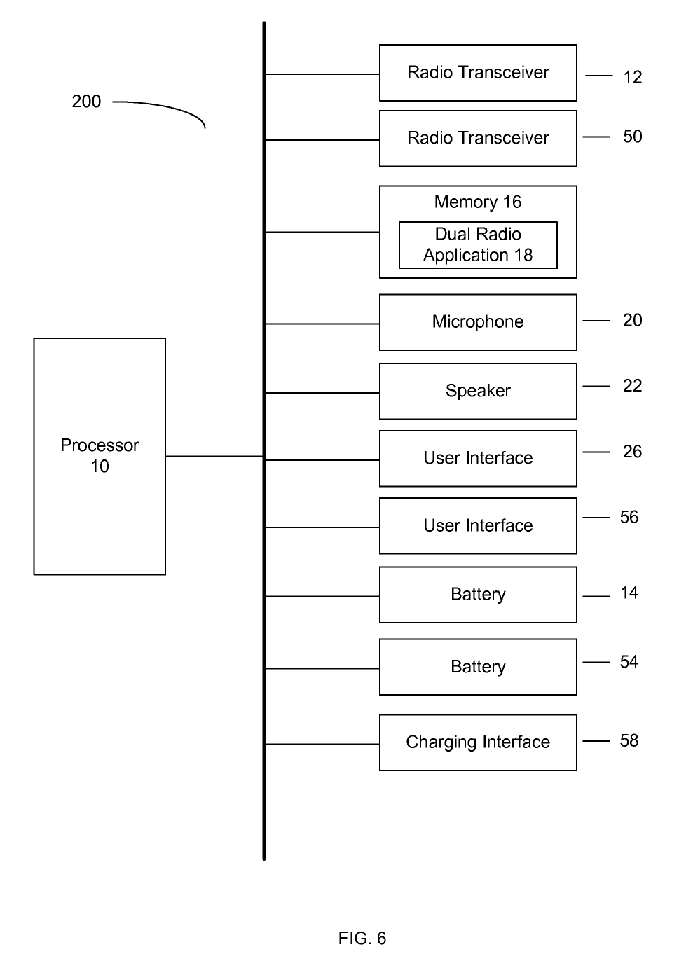

FIG. 4 illustrates a block diagram of a secondary radio module 4 in one example. Secondary radio module 4 includes a radio transceiver 50 and a headset module interface 52. Radio transceiver 50 provides for communications with a wireless local area network (LAN) radio transceiver. The radio transceiver 12 may communicate using any of various protocols known in the art for wireless connectivity. For example, radio transceiver 50 may communicate using Bluetooth, DECT, wireless fidelity (WiFi), or ultra wideband (UWB) radio with a base unit radio transceiver for access to a network.

In one example configuration of modular headset system 100, radio transceiver 50 at secondary radio module 4 is a DECT radio and radio transceiver 12 at the headset module 2 is a Bluetooth radio. Headset module interface 52 may, for example, be a mini-USB interface.

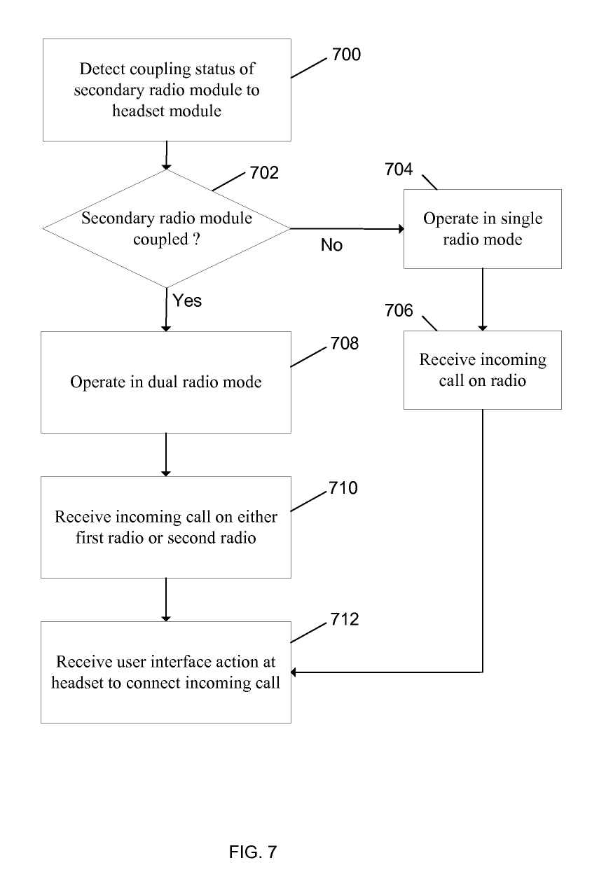

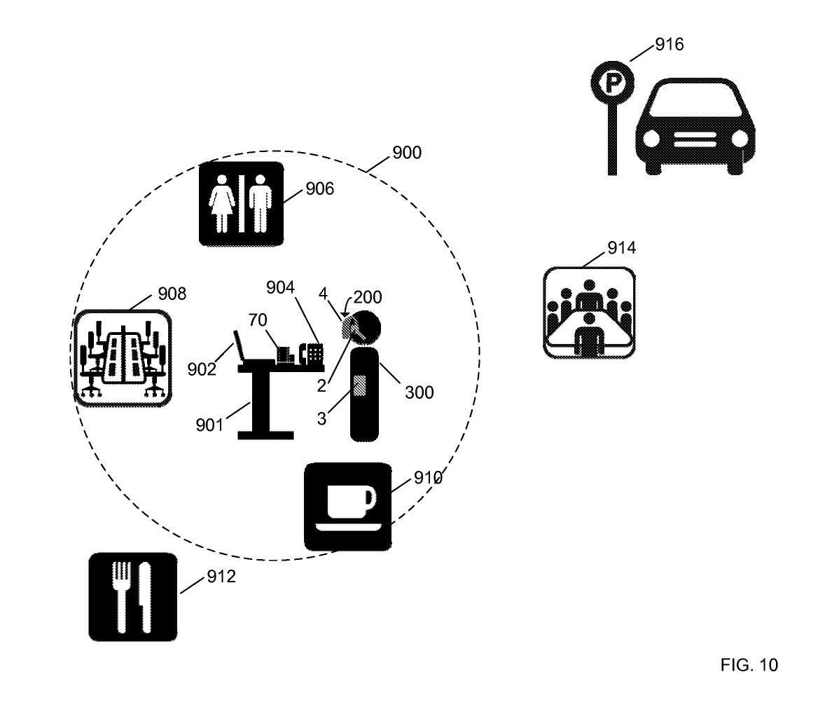

FIG. 5 illustrates a block diagram of a secondary radio module 4 in a further example. In the example shown in FIG. 5, secondary radio module 4 includes a radio transceiver 50, battery 54, headset module interface 52, user interface 56, and charging interface 58. Charging interface 58 is adapted to receive charging power from a headset base as shown in FIG. 8. In one example, charging interface 58 is a mini-USB interface. In one example, the secondary radio module 4 utilizes a housing adapted to form an over-the-ear headset with the headset module 2 when the headset module interface 52 is coupled to the secondary radio module interface 24.

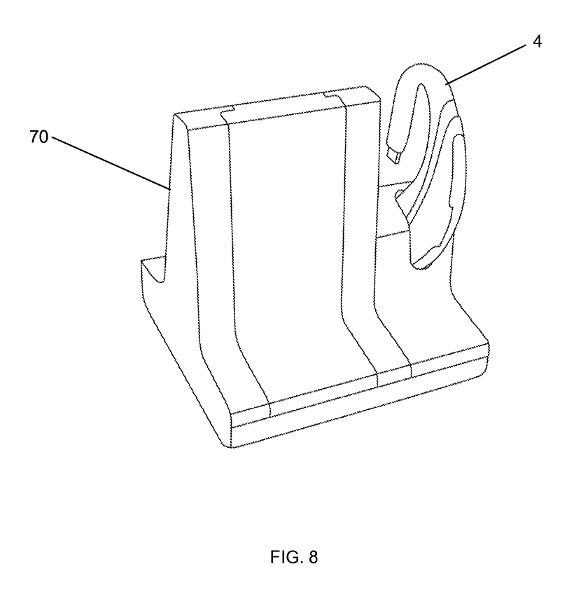

FIG. 6 illustrates a simplified block diagram of a modular headset system 200 in one example whereby the headset module 2 illustrated in FIG. 3 has been coupled with the secondary radio module 4 illustrated in FIG. 5. As shown in FIG. 6, modular headset system 200 includes a processor 10 operably coupled to a radio transceiver 12, radio transceiver 50, memory 16, microphone 20, speaker 22, user interface 26, user interface 56, battery 14, battery 54, and charging interface 58. A dual radio application 18 resides in memory 16. Dual radio application 18 is executed by processor 10 to allow modular headset system 200 to conduct calls, or receive or make calls, utilizing either the radio transceiver 12 or the radio transceiver 50.

As described previously, radio transceiver 12 and radio transceiver 50 may utilize a variety of wireless communication protocols. In one advantageous example, radio transceiver 12 is a Bluetooth radio and radio transceiver 50 is a DECT radio. In this configuration, modular headset system 200 utilizes common protocols aligned with typical user usage patterns. The Bluetooth radio transceiver enables a Bluetooth headset for use with one or more mobile devices while the DECT transceiver enables the use of a high quality DECT link when within range of a DECT base transceiver.

A call answer user interface action at the modular headset system 200 is performed to answer and connect an incoming call. A single user interface action may be used to answer a call received on either radio transceiver 12 or radio transceiver 50. In a further example, there is a dedicated user interface to answer a radio transceiver 12 call and a dedicated user interface to answer a radio transceiver 50 call, such as separate call answer buttons for each type of call. In one example, a user initiates a call at a telephone device such as a mobile phone, desk phone, or PC softphone. The selected device makes the outgoing call and forms a wireless link to the headset using the appropriate wireless protocol. In a further example, a user initiates a call at the modular headset system 200 by selecting either the radio transceiver 12 or the radio transceiver 50. The modular headset system 200 then links to the appropriate device based on the selected radio transceiver. In this manner, initiation of the call and the wireless link between the headset and a telephone can be performed by either device.

In particular, modular headset system 200 advantageously receives user input at both user interface 26 and user interface 56. The headset module 2 controls overall operation of the combined modular headset system 200. Call control functions can be performed at the headset module user interface 26, secondary radio module user interface 56, or a combination thereof. In a further example, the secondary radio module 4 contains only a radio transceiver 50 and does not have a user interface to perform call control functions.

Furthermore, modular headset system 200 may advantageously use both battery 14 and battery 54 to power modular headset system 200, thereby extending operation time of modular headset system 200 operating in either single radio mode or dual radio mode. A charging interface 58 may be utilized to provide charging power to both battery 14 and battery 54. In addition, battery 54 may provide charging power to battery 14. This is particularly advantageous where secondary radio module 4 has a larger form factor and thus provides the ability to house a larger battery 54 relative to battery 14 at headset module 2. When decoupled, the headset module 2 will thereby have a re-charged battery for extended operation in single radio mode.

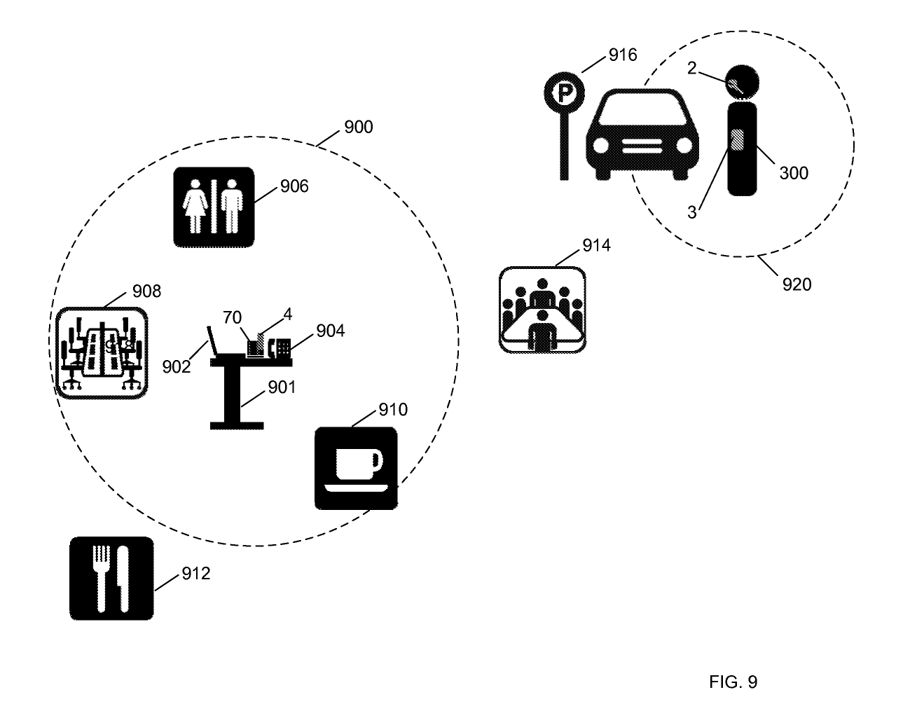

FIG. 7 is a flow diagram illustrating a process for operating a modular headset system in one example. At block 700, a coupling status of a secondary radio module to a headset module is detected. At decision block 702, it is determined whether the secondary radio module is coupled. If no at decision block 702, at block 704 the modular headset system is operated in single radio mode. In single radio mode, the user may utilize the headset module with a corresponding paired device using the radio transceiver at the headset module. For example, the user may conduct voice communications over a wireless link with a paired device. In a further example, the user may also make and receive calls at the headset module using the radio transceiver at the headset module.

Following block 704, at block 706 an incoming call is received on the headset module radio. Following block 706, the process proceeds to block 712. At block 712, a user interface action is received to connect the incoming call.

If yes at decision block 702, at block 708 the modular headset system is operated in dual radio mode. In dual radio mode, the user may utilize the modular headset system with corresponding paired devices using either the radio transceiver at the secondary radio module or the radio transceiver at the headset module. For example, the user may conduct voice communications over a wireless link with the corresponding paired device. In a further example, the user may also make and receive calls at the modular headset system using the radio transceiver at the secondary radio module or the radio transceiver at the headset module.

In one example, charging of a headset module battery with a secondary radio module battery is initiated following coupling of the secondary radio module to the headset module. At block 710, an incoming call is received on either the headset module radio or the secondary radio module radio.

At block 712, a user interface action is received at the modular headset system to connect the incoming call. In one example, receiving a user interface action at the modular headset system to connect the incoming call includes receiving a user interface action at a user interface disposed on a secondary radio module housing. In a further example, receiving a user interface action at the modular headset system to connect the incoming call includes receiving a user interface action at a first user interface input to connect a call on the first radio and receiving a user interface action at a second user interface input to receive a call on the second radio. In yet another example, receiving a user interface action at the modular headset system to connect the incoming call comprises receiving a user interface action at a single user interface input to connect a call on either the first radio or the second radio. The process further includes, responsive to detecting decoupling of the secondary radio module, switching from a dual radio mode to a single radio mode.

FIG. 8 illustrates recharging of a secondary radio module 4 in a headset base 70 in one example. Advantageously, the user can de-couple the headset module 2 for mobile operation, such as that outside the office. The secondary radio module 4 can also be inserted into headset base 70 while coupled to headset module 2. When the coupled secondary radio module 4 is inserted into the headset base 70, both the headset module battery and the secondary radio module battery are charged. In one example, headset base 70 is connected to both a PC for VoIP calls and a landline telephone for PSTN calls. Headset base 70 includes a radio transceiver for wireless communication with secondary radio module 4.

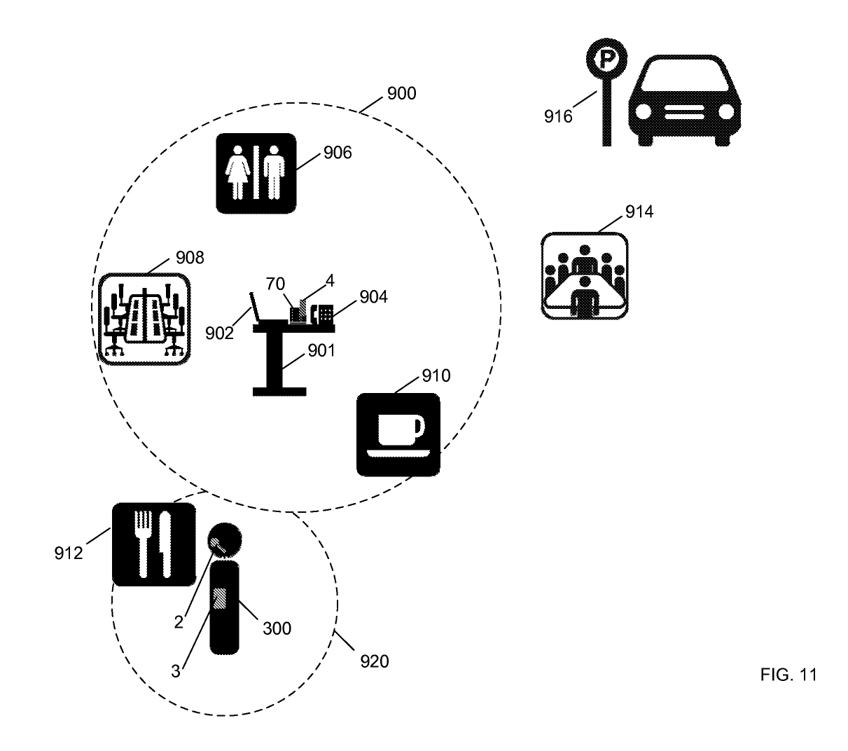

FIGS. 9-11 illustrate usage scenarios for a modular headset system. As shown in FIGS. 9-11, a user in an office environment typically has a personal computer 902 and a wired telephone 904 located at his or her desk 901. A headset base 70 is coupled to personal computer 902, telephone 904, or both. Headset base 70 includes a wireless transceiver. For example, the wireless transceiver may utilize the DECT protocol. The headset base wireless transceiver has a base wireless communication range 900, within which the base 70 can transmit communications to an associated headset and receive communications from the headset. In the example shown in FIGS. 9-11, a restroom 906, conference room 908, and coffee station 910 are all located within the base wireless communication range 900. A dining room 912 and conference room 914 are located outside the base wireless communication range 900. Also located outside the base wireless communication range 900 is a user parking location 916. For example, user parking location 916 may be located in a parking garage adjacent to the user's office building.

In the usage scenario shown in FIG. 9, a user 300 is located at his parking location 916. For example, user 300 may have just arrived at the start of the work day. User 300 carries a mobile phone 3 and a headset module 2. In one example, mobile phone 3 and headset module 2 utilize Bluetooth protocol transceivers having a wireless communication range 920. As shown in FIG. 9, a secondary radio module 4, de-coupled from the headset module 2, is currently located at headset base 70. In this scenario, the headset module 2 is operable in single radio mode, capable only of communications with mobile phone 3. The user 300 may receive and make calls with mobile phone 3.

In the usage scenario shown in FIG. 10, the user 300 has moved from parking location 916 to his desk 901. The user 300 has removed secondary radio module 4 and coupled it to headset module 2, forming a modular headset system 200. The modular headset system 200 is operable in dual radio mode, capable of utilizing either the radio transceiver inside headset module 2 or the radio transceiver inside secondary radio module 4. The user 300 may receive and make calls with personal computer 902 or telephone 904 and use the modular headset system 200 for voice communications via the headset base 70, in which case the secondary radio module transceiver is used. The user 300 may roam anywhere within base wireless communication range 900 and still be capable of receiving and making calls with personal computer 902 or telephone 904. For example, the user 300 may participate in a call while located at restroom 906, conference room 908, or coffee station 910. The user 300 may also continue to receive and make calls with mobile phone 3 using modular headset system 200.

In a usage scenario shown in FIG. 11, the user 300 has moved from his desk 901 to an area outside of base wireless communication range 900. When moving outside of base wireless communication range 900, the user 300 may select to de-couple the secondary radio module 4 from the headset module 2 as shown in FIG. 11. The user 300 may place secondary radio module 4 in headset base 70 for recharging and storage since it will no longer be needed outside of base wireless communication range 900. This allows the user 300 to carry a smaller form factor headset. Alternatively, the user 300 may elect to leave the secondary radio module 4 coupled to utilize the secondary radio module battery to power the headset module if the headset module battery power is low. Outside base wireless communication range 900, the headset module 2 is operable in single radio mode, and the user 300 may receive and make calls with mobile phone 3.

While the exemplary embodiments of the present invention are described and illustrated herein, it will be appreciated that they are merely illustrative and that modifications can be made to these embodiments without departing from the spirit and scope of the invention. For example, the type of connector used between the headset module and the secondary radio module may be varied, and the devices being used to wirelessly link with either the headset module or the secondary radio module may be varied. Thus, the scope of the invention is intended to be defined only in terms of the following claims as may be amended, with each claim being expressly incorporated into this Description of Specific Embodiments as an embodiment of the invention.

What is claimed is:

1. A headset system comprising:
a first radio module comprising:
a first radio transceiver; and
a first connection interface; and
a headset module comprising:
a second radio transceiver;
a processor;
a speaker;
a microphone;
a battery;
a user interface; and
a second connection interface adapted to removably couple to the first connection interface, wherein the headset module is adapted to utilize either the first radio transceiver or the second radio transceiver when coupled to the first radio module.

2. The headset system of claim 1, wherein the first connection interface and the second connection interface are components of a mini-USB interface.

3. The headset system of claim 1, wherein the first radio module or the headset module further comprise a charging interface adapted to receive charging power.

4. The headset system of claim 1, wherein the headset module is operable as a standalone wireless headset when decoupled from the first radio module.

5. A headset system comprising:
a DECT module comprising:
a DECT radio transceiver; and
a first connection interface; and
a Bluetooth headset module comprising:
a Bluetooth radio transceiver;
a processor;
a speaker;
a microphone;
a battery;
a user interface;
a second connection interface adapted to removably couple to the first connection interface; and
a memory storing a dual radio application configured to operate the headset system in a dual radio mode upon detection of a coupled DECT module.

6. The headset system of claim 5, wherein the first connection interface and the second connection interface are components of a mini-USB interface.

7. The headset system of claim 5, wherein the DECT module further comprises a charging interface adapted to receive charging power.

8. The headset system of claim 5, wherein the DECT module further comprising a housing adapted to form an over-the-ear headset when the first connection interface is coupled to the second connection interface.

9. The headset system of claim 5, wherein the DECT module further comprises a charging interface adapted to receive charging power from a headset base.

10. A headset system comprising:
a secondary radio module comprising:
a first radio transceiver;
a first battery;
a first user interface;
a first connection interface; and
a headset module comprising:
a second radio transceiver;
a processor;
a speaker;
a microphone;
a second battery;
a second user interface;
a second connection interface adapted to removably couple to the first connection interface; and
a memory storing a dual radio application configured to receive a call over the first radio transceiver or the second radio transceiver upon detection of a coupled secondary radio module.

11. The headset system of claim 10, wherein the first radio transceiver comprises a DECT radio transceiver and the second radio transceiver comprises a Bluetooth radio transceiver.

12. The headset system of claim 10, wherein the first connection interface and the second connection interface are components of a mini-USB interface

13. The headset system of claim 10, wherein the first battery or the second battery provide power to the headset system when the secondary radio module and the headset module are coupled.

14. The headset system of claim 10, wherein the first battery provides charging power to the second battery when the secondary radio module and the headset module are coupled.

15. The headset system of claim 10, wherein the dual radio application is configured to receive user input from both the first user interface and the second user interface when the secondary radio module and the headset module are coupled.

16. The headset system of claim 10, wherein the secondary radio module further comprising a housing adapted to form an over-the-ear headset when the first connection interface is coupled to the second connection interface.

17. The headset system of claim 10, wherein the secondary radio module further comprises a charging interface adapted to receive charging power from a headset base.

18. A computer readable medium storing instructions that when executed by a computer cause the computer to perform a method for operating a modular headset comprising:
detecting coupling or decoupling of a secondary radio module to a headset;
responsive to detecting coupling of the secondary radio module, switching from a single radio mode to a dual radio mode;
receiving an incoming call on either a first radio transceiver or a second radio transceiver while in a dual radio mode; and
receiving a user interface action at the headset to connect the incoming call.

19. The computer readable medium of claim 18, wherein the first radio transceiver comprises a DECT radio transceiver and the second radio transceiver comprises a Bluetooth radio transceiver.

20. The computer readable medium of claim 18, wherein receiving a user interface action at the headset to connect the incoming call comprises receiving a user interface action at a user interface disposed on a secondary radio module housing.

21. The computer readable medium of claim 18, the method further comprising, responsive to detecting decoupling of the secondary radio module, switching from a dual radio mode to a single radio mode.

22. The computer readable medium of claim 18, wherein receiving a user interface action at the headset to connect the incoming call comprises receiving a user interface action at a first user interface input to connect a call on the first radio transceiver and receiving a user interface action at a second user interface input to receive a call on the second radio transceiver.

23. The computer readable medium of claim 18, wherein receiving a user interface action at the headset to connect the incoming call comprises receiving a user interface action at a single user interface input to connect a call on either the first radio transceiver or the second radio transceiver.

24. The computer readable medium of claim 18, further comprising initiating charging of a headset battery with a secondary radio module battery following coupling of the secondary radio module to the headset.
